(19) United States
(12) Patent Application Publication
(10) Pub. No.: US 2020/0389577 A1
(43) Pub. Date: Dec. 10, 2020

(54) IMAGE CAPTURING APPARATUS

(71) Applicant: CANON KABUSHIKI KAISHA, Tokyo (JP)

(72) Inventor: Ryuji Tanaami, Yokohama-shi (JP)

(21) Appl. No.: 16/884,373

(22) Filed: May 27, 2020

(30) Foreign Application Priority Data
Jun. 4, 2019 (JP) 2019-104561

(51) Int. Cl. H04N 5/225; H04N 7/18

(52) U.S. Cl. CPC H04N 5/2258; H04N 7/18; H04N 5/2256; H04N 5/2252

(57) ABSTRACT

An image capturing apparatus that enables omnidirectional shooting and is compatible with shooting in various scenes is provided. An image capturing apparatus comprises: a housing 101 having a shape which can be mounted on a user; a plurality of image capturing units arranged in the housing 101 and that enables omnidirectional shooting; and a first illumination unit arranged in the housing and configured to emit a first light to at least a part of an imaging region.

### BACKGROUND OF THE INVENTION

### Field of the Invention

The present invention relates to an image capturing apparatus.

### Description of the Related Art

In recent years, a wearable camera has been well known as an image capturing apparatus that can be worn on a human body. The wearable camera has various forms, and the form of shooting in the front direction by hanging the camera from the neck or hanging it over the ear is well known. The wearable camera has various usages. For example, for the police, the wearable camera is used as a unit for leaving documentary evidence by shooting for a long time. For general consumers, the wearable camera is used as a unit for keeping daily records.

While many conventional wearable cameras are designed to mainly shoot in a forward direction, many handheld cameras, known as “action cameras”, can perform omnidirectional shooting. A user selects the wearable camera or a handheld omnidirectional camera depending on the purposes, and a need for hands-free omnidirectional shooting is increasing.

The wearable camera can be used in various situations. For example, for the police, it is conceivable that the wearable camera is used for day or night patrols. Video images that have been shot may be recorded as a color video image or may be recorded as a monochrome video image depending on the shooting environment. For example, in shooting in a bright environment, visible light is received by the image capturing unit and recorded as a color image. In contrast, in shooting in a dark environment where the visible light cannot be received, near-infrared light is received and recorded as a monochrome image. In such a dark environment, an illumination unit is required, where a wavelength band necessary for the illumination unit varies depending on the purpose. Japanese Patent No. 5841687 proposes a configuration in which an LED light is worn on a head and a control unit having an ON/OFF switch for the LED light is carried on the back.

Japanese Patent No. 5841687 is useful in an environment where the emission of the visible light in one direction is sufficient such as for surgery. However, in the wearable camera that may be used in various scenes whether indoors or outdoors, a desired image may not be acquired only by emitting the visible light in one direction.

### SUMMARY OF THE INVENTION

The present invention is to provide an image capturing apparatus that enables omnidirectional shooting and is compatible with shooting in various scenes.

In order to solve the above problem, an embodiment of the present invention comprises: a housing which can be mounted on a user; a plurality of image capturing units arranged in the housing and that enables omnidirectional shooting; and a first illumination unit arranged in the housing and configured to emit a first light to at least a part of an imaging region.

Further features of the present invention will become apparent from the following description of experimental artifacts with reference to the attached drawings.

### BRIEF DESCRIPTION OF THE DRAWINGS

FIG. 1 is a perspective diagram illustrating the appearance of a wearable camera according to the first embodiment.

FIG. 2 is a top view of the wearable camera according to the first embodiment.

FIG. 3 illustrate a state in which a cover is removed

FIGS. 4A and 4B illustrate a state in which the wearable camera is worn on a human body.

FIG. 5 is a perspective view illustrating the appearance of the wearable camera according to the second embodiment.

FIG. 6 is a top view of the wearable camera according to the second embodiment.

FIG. 7 is a block diagram illustrating the internal configuration of the wearable camera according to the second embodiment.

FIG. 8 is a perspective view illustrating the appearance of the wearable camera according to the third embodiment.

FIG. 9 is a block diagram illustrating the internal configuration of the wearable camera according to the third embodiment.

FIGS. 10A and 10B are explanatory views of the wearable camera according to the fourth embodiment.

FIG. 11 is a block diagram illustrating the internal configuration of the wearable camera according to the fourth embodiment.

### DESCRIPTION OF THE EMBODIMENTS

Preferred embodiments of the present invention will now be described in detail with reference to the accompanying drawings. Note that the configuration shown in the following embodiments is only an example and the present invention is not limited to the configuration shown in the drawings.

### First Embodiment

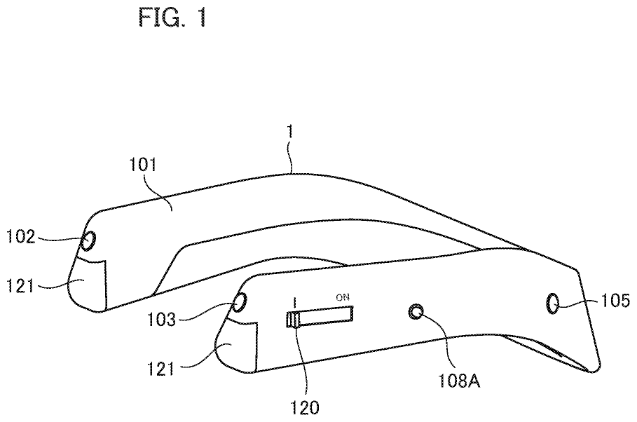

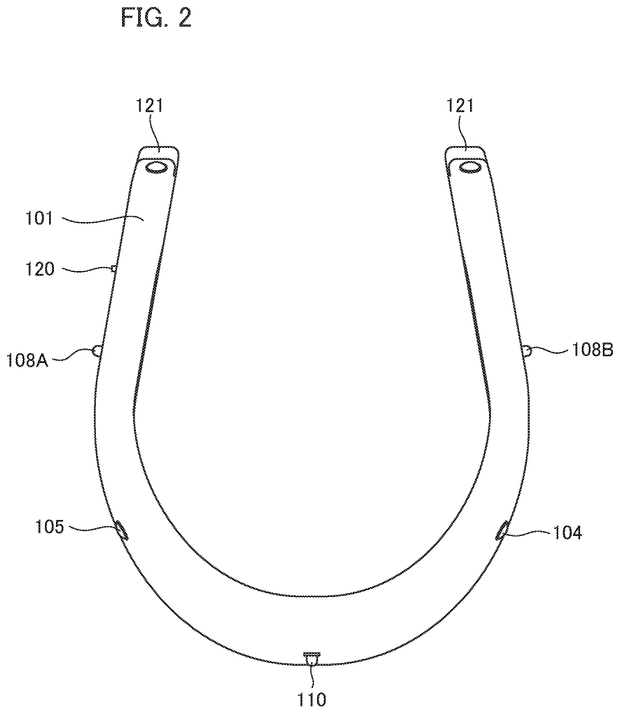

The first embodiment of the present invention will be described in detail with reference to FIGS. 1 to 4. FIG. 1 is a perspective view illustrating the appearance of a wearable camera 1 according to the first embodiment. FIG. 2 is a top view of the wearable camera 1 according to the first embodiment. The wearable camera 1 is an image capturing apparatus used by being hung on the shoulder of a user (photographer). It can also be said that the wearable camera 1 is worn on the neck of the user.

A housing 101 has a U-shape that opens at the front and is formed to cover the neck of the human body. In other words, the housing 101 has a shape that aligns with the neck of the user who is wearing the wearable camera 1.

The housing 101 is provided with first image capturing unit 102 to fourth image capturing unit 105, which include an optical member such as a lens (not illustrated) and an imaging sensor (not illustrated). The first image capturing unit 102 and the second image capturing unit 103 mainly shoot in the front direction of the user who is wearing the wearable camera 1, and the third image capturing unit 104 and the fourth image capturing unit 105 shoot in the lateral and rear directions of the user. Omnidirectional shooting is allowed by using the four image capturing units.

Optical filters (not illustrated) are respectively built in the first image capturing unit 102 to the fourth image capturing unit 105. A color video image can be acquired in an environment where illuminance is sufficient such as in the daytime, and a monochrome video image can be acquired in an environment where illuminance is insufficient such as at night by receiving near-infrared light. Examples of the optical filter include an IR (infrared) cut filter. In an environment where illuminance is sufficient, the IR cut filter is inserted into an optical path to receive only visible light. In contrast, in an environment where illuminance is insufficient, the IR cut filter is retracted from the optical path to receive the near-infrared light to acquire a monochrome video image. Alternatively, a bandpass filter may be used to receive only the near-infrared light, and the configuration of the present invention is not limited. In the present embodiment, the wearable camera 1 includes four image capturing units. However, three or less or five or more image capturing units may be included if omnidirectional shooting, in other words, shooting in 360° around the user who is wearing the wearable camera 1, is possible. The term “image capturing unit”, to be simply described below, includes the first image capturing unit 102 to the fourth image capturing unit 105.

The housing 101 is provided with a plurality of illumination units corresponding to the purpose so as to be able to perform shooting even in an environment where illuminance is insufficient. The ON/OFF of these illumination units may be switched by, for example, a switch 120. The switch 120 is, for example, a sliding switch that can be operated by the user.

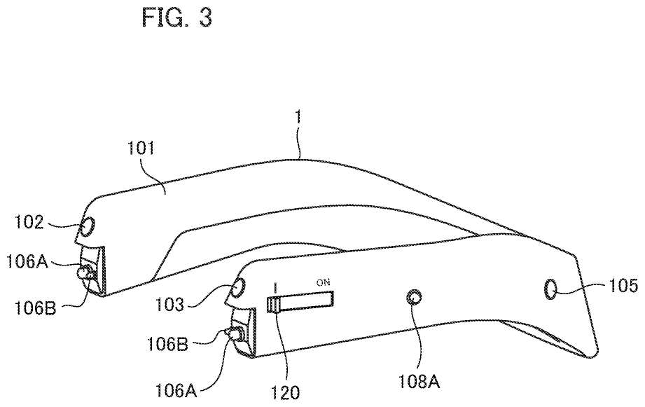

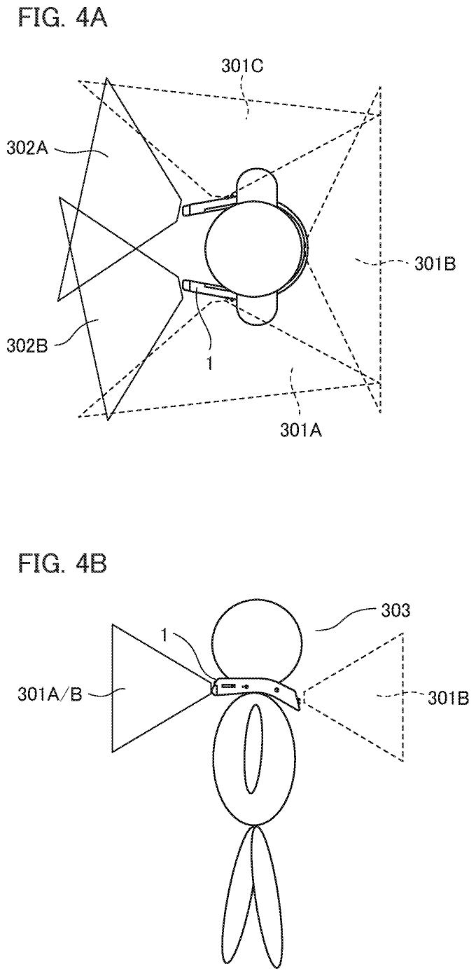

As shown in FIG. 1, a cover 121 is provided on the front side when the user is wearing the wearable camera 1. FIG. 3 illustrates a state in which the cover 121 is removed. FIG. 4 illustrates a state in which the wearable camera 1 is worn on a human body 303. FIG. 4A is a top view of a state in which the wearable camera 1 is worn on the human body 303 and FIG. 4B is a side view in which the wearable camera 1 is worn on the human body 303.

A first illumination unit emits a first light having a wavelength included in a near-infrared wavelength band so as to be able to acquire a monochrome image even in an environment where illuminance is less than a predetermined illuminance, for example, an environment where there is no light, such as darkness. The first light is preferably the near-infrared light having a center wavelength of 850 nm. The first illumination unit is disposed on the outer peripheral surface of the housing 101 so as to be able emitting the first light in the lateral and the rear directions, and emits the first light to an object (object to be captured) or at least a part of an imaging region. Specifically, in order to emit the light in the front direction of the user who is wearing the wearable camera 1 within emission ranges 302A and 302B, a pair of IREDs 106A is disposed at the right and left ends of the front of the wearable camera 1. An IRED left 108A and an IRED right 108B are disposed on the right and left sides to emit the light to the lateral directions of the user who is wearing the wearable camera 1 within emission ranges 301A and 301C. Additionally, an IRED 110 is disposed at the center of the rear side for emitting the light in the rear direction when the user is wearing the wearable camera 1 within an emission range 301B. The first illumination unit emits the light to the object and the image capturing unit receives the near-infrared light, which is the reflected light thereof, and thereby, a monochrome image can be acquired even in the dark. Note that, the right, left, front, and rear in the present specification are determined based on the user who is wearing the wearable camera.

As a method for acquiring a video image in the dark, for example, a method for illuminating an object and the like by using a white light source such as a halogen lamp is conceivable. Since the white light source emits light having a wide wavelength band, it is compatible with various shooting scenes. However, since the white light source emits light including a visible wavelength, it is difficult to acquire a video image while making the presence of the user himself/herself invisible. Even in such a condition, the video image can be acquired by emitting the near-infrared light.

A second illumination unit emits a second light having a wavelength that is different from the first light and is included in the visible wavelength band so that the user can visually observe the front direction or the like even in an environment where there is no light, such as in the dark. The second light is preferably visible light having a wavelength band of 400 to 700 nm. The second illumination unit is disposed on the outer peripheral surface of the housing 101 so as to be able to emit the second light in the front direction. Specifically, in order to emit the light in the front direction when the user is wearing the wearable camera 1 within the emission ranges 302A and 302B, a pair of LEDs 106B are disposed at the right and left ends of the front side when the user is wearing the wearable camera 1. By illuminating the front direction with the second illumination unit, the front direction can be visually observed even in an environment where there is no light, such as in the dark.

The first and second illumination units are switched on and off, for example, depending on the brightness of the shooting environment. More specifically, the housing 101 is provided with an illuminance sensor (not illustrated), and when the illuminance detected by the illuminance sensor is higher than a predetermined threshold, it is determined that illumination is unnecessary and the first and second illumination units are turned off. In contrast, when the detected illuminance is lower than a predetermined threshold, it is determined that illumination is necessary and the first and second illumination units are turned on. Since control using the illuminance sensor is a known technique, the details thereof will be omitted.

The wearable camera is often and typically used to shoot not only when the user stops, but also during the movement of the user, such as walking. For example, in night photography, only emitting the near-infrared light for acquiring a monochrome image is too dark for visual observation in the user's traveling direction, so that shooting while the user is walking is difficult. However, night photography becomes easy by illuminating the traveling direction with the visible light for visual observation as in the present embodiment.

As described above, a hanging type wearable camera that enables shooting during day and night can be achieved by arranging illuminations each having different wavelength bands. For example, during patrol in a dark environment where there is no light, such as darkness, it is desirable to be able to visually observe the front direction. Hence, it is desirable to emit visible illumination in the front direction and to emit near-infrared illumination in the lateral and rear directions so that monochrome images can be acquired even in the dark. The near-infrared light is desirably emitted omnidirectionally, for example, if the user wants to record a video image while making the presence of the user herself/himself invisible during an investigation in the dark.

In the present embodiment, although the IRED or the LED is used to serve as the unit of illumination, another means may be used if the means can be used as illumination for a human such as a low-light laser. As long as light can be emitted to a desired range, the number and position of the light sources to be arranged are not limited to the configuration described in the present embodiment. Although the wavelength of the light source is 400 to 700 nm in the visible light and is 850 nm in the center wavelength of the near-infrared light, other wavelengths may be allowed. Further, a configuration in which only one of the first illumination unit and the second illumination unit is provided is allowed.

### Second Embodiment

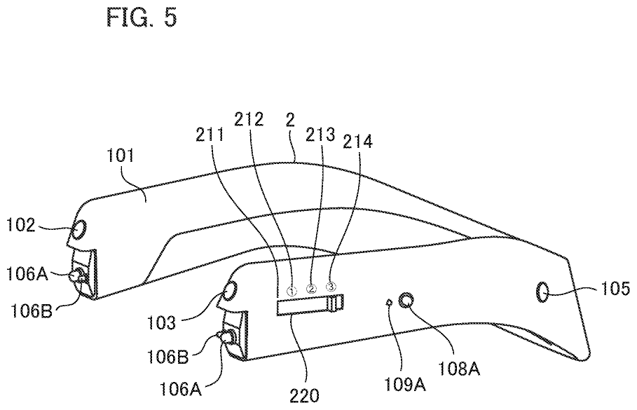

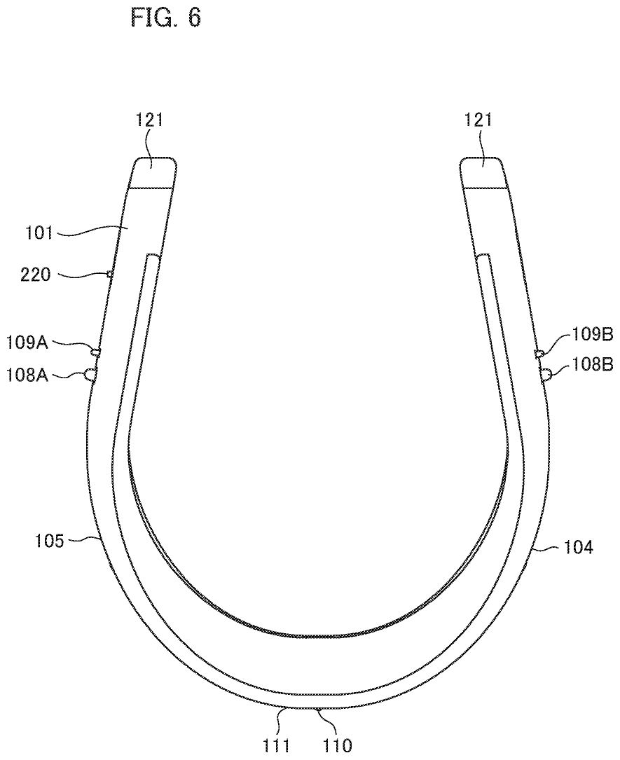

In the first embodiment, the front direction is illuminated by visible light and near-infrared light, and the lateral and rear directions are illuminated by near-infrared light. In some shooting scenes, it is desirable to appropriately switch these illuminations by input from the user. The details will be described with reference to FIGS. 5 and 6, and redundant description will be omitted.

FIG. 5 is a perspective view illustrating the appearance of a wearable camera 2 according to the second embodiment. The drawing shows a state in which the cover 121 covering the front illumination is removed. FIG. 6 is a top view of the wearable camera 2 according to the second embodiment. The image capturing unit is disposed in a manner similar to that in the first embodiment.

In addition to the illumination units described in the first embodiment, an LED 109A, an LED 109B, and an LED 111, which are visible light sources having a wavelength band of 400 to 700 nm, are arranged on the lateral and rear sides. The arrangement of these illumination units allows a configuration in which the visible light and the near-infrared light can be emitted omnidirectionally. In some shooting scenes, these illumination units are desirably switched appropriately. For example, in the case where the illuminance is insufficient in the acquisition of a color image, but the color image can be acquired if there is an illumination unit that illuminates auxiliary visible light, for example, during patrol at dusk, it is desirable to be able to emit the visible light omnidirectionally. Additionally, if a color image is difficult to acquire, for example, during a patrol in the dark, it is desirable to be able to emit the visible light for visual observation in the front direction and emit the near-infrared light for acquiring a monochrome video image. Moreover, visual observation is not necessary in the lateral and rear directions, so that it is desirable to emit only the near-infrared light for acquiring a monochrome video image. Furthermore, in some cases, it is desirable to be able to emit the near-infrared light omnidirectionally in order to prevent the other party from realizing that the user himself/herself is present, such as in an investigation in the dark. The flow of switching the illumination units depending on the purposes will be described below.

A sliding switch 220 that can be operated by the user is provided on the side face of the wearable camera 2. The switch 220 can be switched in at least four stages including illumination OFF, and the illumination is switched corresponding to the position of each switch. For example, in a first position 211 located most forward, the first illumination unit and the second illumination unit are OFF. In a second position 212, visible illumination is emitted omnidirectionally. Specifically, at the second position 212, only all of the second illumination units are turned on. At a third position 213, the visible light and the near-infrared light are emitted in the front direction, and the near-infrared light is emitted in the lateral and rear directions. Specifically, the LED 106B, the IRED 106A, and the IRED 110 are turned on. In a fourth position 214, the near-infrared light is emitted omnidirectionally. In other words, only the first illumination unit is turned on.

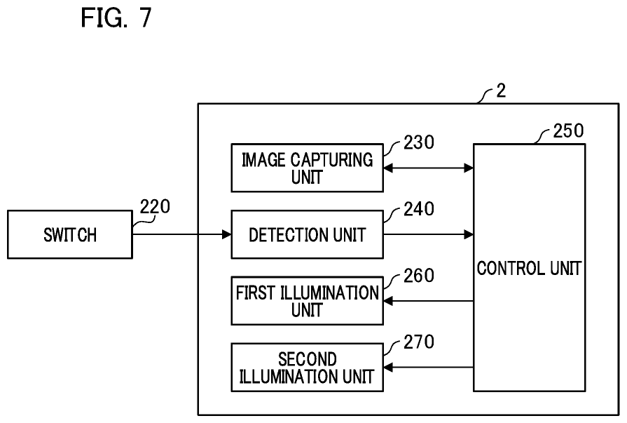

FIG. 7 is a block diagram illustrating an example of the internal configuration of the wearable camera 2 according to the second embodiment. An image capturing unit 230 includes the first image capturing unit 102 to the fourth image capturing unit 105. A detection unit 240 detects an input from the outside. Specifically, the detection unit 240 electrically detects switching of the switch 220. The detection unit 240 outputs the detected electric signal to a control unit 250. The control unit 250 is, for example, a control substrate that controls each unit of the wearable camera 2. The control unit 250 controls a first illumination unit 260 and a second illumination unit 270 based on the detection result of the detection unit 240. Specifically, the control unit 250 performs control including ON/OFF of the first illumination unit 260 and the second illumination unit 270 based on the electric signal output from the switch 220.

As described above, a small wearable camera that can shoot various scenes can be achieved by switching the illuminations having different wavelength bands in accordance with the input from the user. In the present embodiment, although the IRED or the LED is used to serve as the illumination unit, another unit may be used as long as it can be used as illumination for a human such as a low-light laser. The number and position of the light sources to be arranged are not limited to the configuration described in the present embodiment if a desired range can be illuminated.

### Third Embodiment

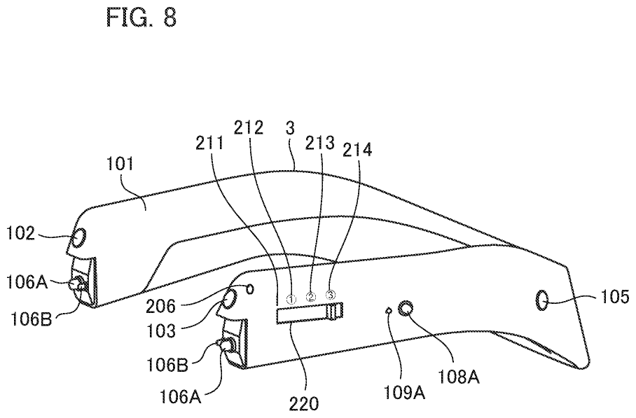

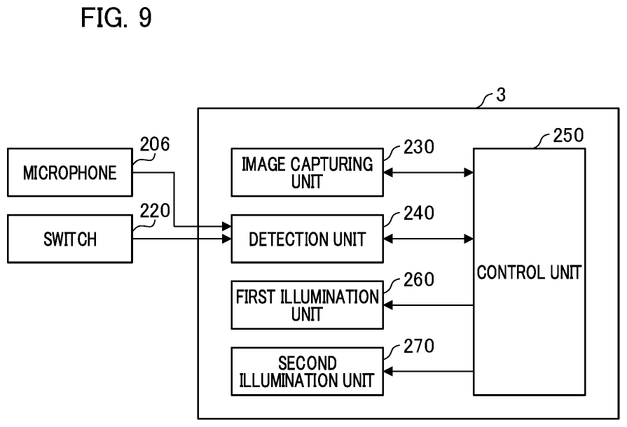

In the second embodiment, although a configuration in which the sliding switch 220 that can be operated by the user is used has been proposed as an input method from a user, the input method from the user includes not only a physical switch, but also voice input. The configuration will be described below with reference to FIG. 8 and FIG. 9.

FIG. 8 is a perspective view illustrating the appearance of a wearable camera 3 according to the third embodiment. The drawing shows a state in which the cover 121 covering the front illumination is removed. Since the arrangement of the image capturing unit, the first illumination unit and the second illumination unit, and the switch 220 in the present embodiment are the same as those in the second embodiment, the description thereof will be omitted.

In the present embodiment, a microphone 206 is disposed at the front side of the housing 101 when the user is wearing the wearable camera 3. Although the microphone 206 may be, for example, a MEMS microphone, it may be another microphone. The microphone 206 collects, for example, the user's voice.

FIG. 9 is a block diagram illustrating an example of the internal configuration of the wearable camera 3 according to the third embodiment. When a user utters a word as a sound instruction to the microphone 206, the detection unit 240 detects the word. The detection unit 240 outputs the spoken sound to the control unit 250. The control unit 250 processes the spoken sound, converts the processed result into a signal, and controls the first illumination unit 260 and the second illumination unit 270 based on the signal.

A mode may be provided in which the user can select an effective input unit depending on the situation by a plurality of input units provided for controlling the first illumination unit 260 and the second illumination unit 270. For example, if it is desired not to switch the illumination unintentionally, the control by the voice input may be disabled and only the control by the switch 220 may be enabled. In contrast, if convenience is sought, the first illumination unit 260 and the second illumination unit 270 may be controlled hands-free by enabling voice input in addition to input by the switch 220.

With the above configuration, the first illumination unit 260 and the second illumination unit 270 can be easily controlled, so that a small wearable camera that enables shooting in various scenes can be achieved.

In the present embodiment, the first illumination unit 260 and the second illumination unit 270 can be controlled by the switching operation and voice input. However, the first illumination unit 260 and the second illumination unit 270 may be controlled by providing an operation sensor that detects a gesture (operation) of the user to the wearable camera 3 and detecting the operation performed on the operation sensor by the detection unit 240. For example, a human sensor, a gyro sensor, or an acceleration sensor may be used to serve as a motion sensor.

The human sensor detects the human body 303 by using, for example, infrared light, ultrasonic waves, visible light, or a combination thereof, and the detection unit 240 detects the operation of the user based on the detection. For example, the user may hold his/her hand over the human sensor to control the first illumination unit 260 and the second illumination unit 270. The gyro sensor detects an angular velocity (specifically, a rotation angle per unit time) of the wearable camera 3 and the detection unit 240 detects the operation of the user based on the angular velocity. The acceleration sensor detects acceleration in the three-axis direction (referred to the as x-axis, the y-axis, and the z-axis) of the orthogonal coordinate system of the wearable camera 3, and the detection unit 240 detects the operation of the user based on the acceleration. The other units may be used to serve as the operation sensor or they may be used together.

### Fourth Embodiment

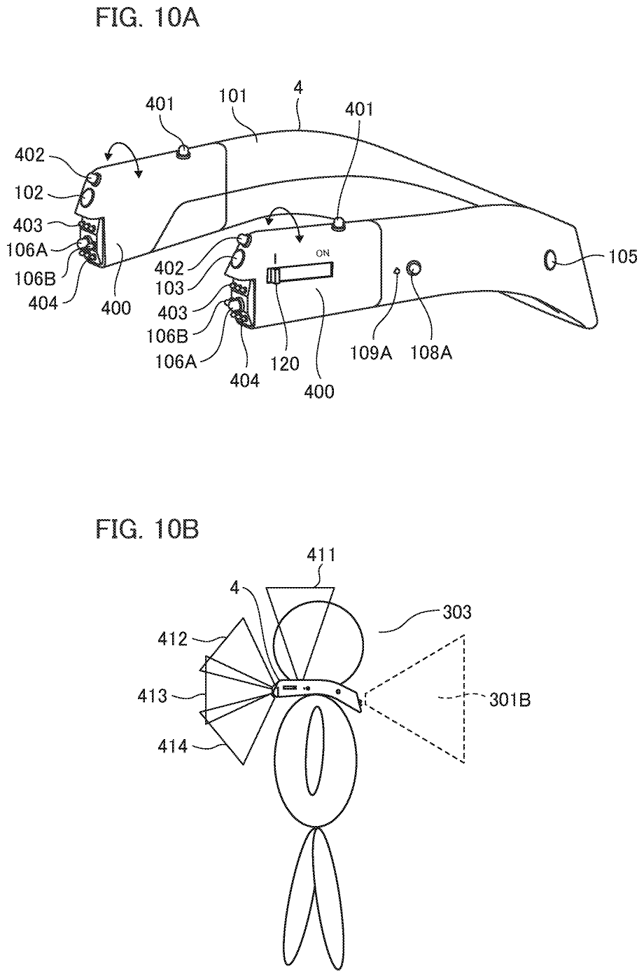

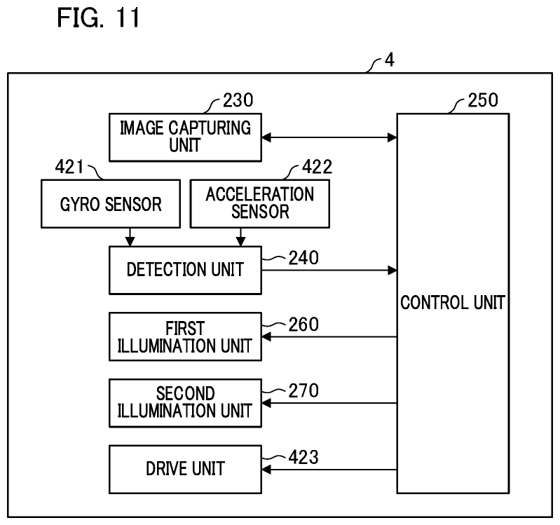

In the fourth embodiment, the range that is illuminated by the first illumination unit is more diverse. The configuration will be described below with reference to FIG. 10 and FIG. 11.

FIG. 10 illustrates a wearable camera 4 according to the fourth embodiment. FIG. 10A is a perspective view illustrating the appearance of the wearable camera 4 according to the fourth embodiment. The drawing shows a state in which the cover 121 covering the front illumination is removed. FIG. 10B illustrates that the wearable camera 4 is worn on the human body 303. The wearable camera 4 includes a pair of the LEDs 106B, the LED 109A, the LED 109B, the LED 111, and in addition, a pair of LEDs 401, a pair of LEDs 402, a pair of LEDs 403, and a pair of LEDs 404, to serve as the second illumination units.

The LED 401 emits the visible light in the upward direction of the user who is wearing the wearable camera 4 within an emission range 411 to illuminate the user's face. The LED 402 emits the visible light in the upper front direction of the user who is wearing the wearable camera 4 within an emission range 412. The LED 403 emits the visible light in the front direction of the user who is wearing the wearable camera 4 within an emission range 413. The LED 404 emits the visible light in the lower front direction of the user who is wearing the wearable camera 4 within an emission range 414.

Additionally, end portions 400 of the housing 101 of the wearable camera 4 in which the LEDs 401 to 404 are arranged are each rotatable around the optical axis of the first image capturing unit 102 or the second image capturing unit 103, which serves as the rotation axis. As described above, the LED that emits light in various ranges is provided and the end portions 400 where the LEDs are arranged are driven, and thereby, the visible light can be appropriately emitted in a range where the user wants to visually observe even in the dark.

Although methods for controlling each light source may be similar to those in the second or third embodiment, for example, the first illumination unit 260 and the second illumination unit 270 may be controlled based on the posture of the user.

FIG. 11 is a block diagram illustrating an example of the internal configuration of the wearable camera 4 according to the fourth embodiment. The wearable camera 4 includes a gyro sensor 421 that detects the posture of the user and an acceleration sensor 422. The gyro sensor 421 detects an angular velocity (specifically, a rotation angle per unit time) of the wearable camera 4. The acceleration sensor 422 detects acceleration in the three-axis direction (referred to as the x-axis, the y-axis, and the z-axis) of the orthogonal coordinate system of the wearable camera 4. The detection unit 240 detects the posture of the user based on outputs from the gyro sensor 421 and the acceleration sensor 422. When the user changes the posture, the detection unit 240 detects the change of the posture based on the signals from the gyro sensor 421 and the acceleration sensor 422. The detection unit 240 outputs signals from the gyro sensor 421 and the acceleration sensor 422 to the control unit 250. The control unit 250 processes the signals and controls the first illumination unit 260, the second illumination unit 270, and a drive unit 423 based on the processed result. The drive unit 423 drives the end portions 400 based on a command of the control unit 250.

Specifically, when the gyro sensor 421 and the acceleration sensor 422 detect, for example, that the user crouches down, the LED 404 is turned on to illuminate the lower front direction of the user. When the gyro sensor 421 and the acceleration sensor 422 detect that the user tilts, the end portions 400 are rotationally driven by the drive unit 423 to illuminate the tilt direction of the user.

According to the above description, it is possible to more appropriately illuminate a range where the user wants to visibly observe even in the dark.

### Other Embodiments

In the embodiments described above, although an example in which the wearable camera is used by being hung on the user's shoulder has been described as an example, the present invention allows a configuration in which the wearable camera can be worn on the head, the chest, or the abdomen.

The present invention may have a configuration in which LED may be discolored. Further, the present invention may have a configuration that includes a mode for flashing the LED.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-104561, filed Jun. 4 2019, which is hereby incorporated by reference wherein in its entirety.

What is claimed is:

1. An image capturing apparatus comprising:
a housing which can be mounted on a user;
a plurality of image capturing units arranged in the housing and that enables omnidirectional imaging; and
a first illumination unit arranged in the housing and configured to emit a first light to at least a part of an imaging region.

2. The image capturing apparatus according to claim 1 further comprising a second illumination unit arranged in the housing and configured to emit a second light having a wavelength that is different from the first light to at least a part of the imaging region.

3. The image capturing apparatus according to claim 2,
wherein the first light is a wavelength included in a near-infrared wavelength band; and
wherein the second light is a wavelength included in a visible wavelength band.

4. The image capturing apparatus according to claim 2,
wherein the first illumination unit and the second illumination unit each have a plurality of light sources and the light sources emit omnidirectional light emission 360° around the user who is mounting the housing.

5. The image capturing apparatus according to claim 2 further comprising an input unit and a detection unit configured to detect an input from the input unit,
wherein the first illumination unit and the second illumination unit are controlled based on a detection result of the detection unit.

6. The image capturing apparatus according to claim 5, wherein the input unit configured to be disposed on the housing and, the input unit has at least one of an input portion input by a user, a microphone, and a motion sensor configured to detect the motion of the user.

7. The image capturing apparatus according to claim 6,
wherein the detection unit detects the operation input on the input unit by a user.

8. The image capturing apparatus according to claim 6,
wherein the detection unit detects a sound collected by the microphone.

9. The image capturing apparatus according to claim 6,
wherein the detection unit detects the motion performed on the motion sensor.

10. The image capturing apparatus according to claim 9,
wherein a posture of the user is acquired based on the detection result detected by the detection unit, and at least one of the first illumination unit and the second illumination unit is controlled based on the posture of the user.

11. The image capturing apparatus according to claim 6 further comprising:
at least two among the input portion, the microphone, and the motion sensor; and
a control unit has a mode in which the detection unit can select a target to be detected based on the operation input on the input unit by a user, the sound collected by the microphone, and the operation performed on the motion sensor.

12. The image capturing apparatus according to claim 1,
wherein the image capturing apparatus is a wearable camera.

13. The image capturing apparatus according to claim 2,
wherein the housing has a shape that aligns with the neck of the user, and
wherein the first illumination unit and a second illumination unit that emits a second light having a wavelength different from the first light are disposed on the outer peripheral surface of the housing when the user is mounting the housing.

14. The image capturing apparatus according to claim 1, wherein the housing has a U-shape.
